(19) United States
(12) Patent Application Publication
(10) Pub. No.: US 2026/0061754 A1
(43) Pub. Date: Mar. 5, 2026

(54) IMAGE FORMING APPARATUS AND METHOD FOR CONTROLLING THE IMAGE FORMING APPARATUS

(71) Applicant: CANON KABUSHIKI KAISHA, Tokyo (JP)

(72) Inventors: YOSHIKAZU SAITO, Tokyo (JP); AKIHIRO TOMIDA, Kanagawa (JP)

(21) Appl. No.: 19/249,003

(22) Filed: Jun. 25, 2025

(30) Foreign Application Priority Data
Aug. 27, 2024 (JP) 2024-145376

(51) Int. Cl. B41J 2/18; B41J 2/175; B41J 2/19

(52) U.S. Cl. CPC B41J 2/18; B41J 2/17523; B41J 2/17596; B41J 2/19

(57) ABSTRACT

There are included a print head printing by ejecting printing agent from a nozzle, a circulation path including an internal flow path of the print head communicating with the nozzle, supplying a printing agent to the print head, and collecting the printing agent not ejected from the print head and through which the printing agent circulates, a removal unit configured to remove dissolved gas in the printing agent, and a control unit configured to control the removal unit and printing-agent circulation in the circulation path. Where the internal flow path is filled with the printing agent, in the circulation path, after first circulation control that the printing agent is continuously circulated for first time while the dissolved gas is removed by the removal unit, the control unit performs second circulation control that the printing-agent circulation performed for second time shorter than the first time is performed intermittently.

### BACKGROUND

### Field of the Technology

The present disclosure relates to an image forming apparatus forming an image on a print medium by ejecting a printing agent and performing printing and a method for controlling the image forming apparatus.

### Description of the Related Art

Japanese Patent Laid-Open No. 2010-083021 discloses a printing apparatus in which a deaeration apparatus removing dissolved gas in an ink is provided in a circulation path supplying the ink as a printing agent to a print head and collecting the ink from the print head.

In the printing apparatus disclosed in Japanese Patent Laid-Open No. 2010-083021, the amount of the dissolved gas in the ink is reduced by circulating the ink with the deaeration apparatus driving in the circulation path and air bubbles generated in the circulation path are made to be dissolved in the ink to reduce the gas generated in the circulation path.

However, the printing apparatus disclosed in Japanese Patent Laid-Open No. 2010-083021 is designed to continue circulating the ink in the circulation path all the time. Thus, pumps to circulate the ink in the circulation path are highly frequently replaced, and this causes high cost.

### SUMMARY

The present disclosure is made in the light of the above problem and provides a technique by which the suppression of the high cost can be achieved while air bubbles are reduced.

An image forming apparatus includes: a print head performing printing by ejecting a supplied printing agent from a nozzle; a circulation path which includes an internal flow path communicating with the nozzle and formed inside the print head, supplies the printing agent to the print head, and collects the printing agent not ejected from the print head and through which the printing agent circulates; a removal unit configured to remove dissolved gas in the printing agent circulating through the circulation path; and a control unit configured to control the removal unit and circulation of the printing agent in the circulation path, wherein in a case where the internal flow path of the print head is filled with the printing agent, in the circulation path, after first circulation control in which the printing agent is continuously circulated for a first time while the dissolved gas is removed by the removal unit is performed, the control unit performs second circulation control in which circulation of the printing agent which is performed for a second time shorter than the first time is intermittently performed.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic configuration diagram of an image forming apparatus;

FIG. 2 is a schematic configuration diagram of a circulation path;

FIG. 3 is a diagram illustrating a flow path (head internal flow path) formed in a print head;

FIG. 4 is a diagram illustrating a flow path formed in an ink ejection part;

FIG. 5 is a block diagram illustrating a configuration of a control system of the image forming apparatus;

FIG. 6 is a diagram describing circulation control of an ink in the circulation path;

FIGS. 7A to 7C are diagrams illustrating execution examples of the circulation control; and

FIG. 8 is a diagram illustrating a modification example of the circulation path.

### DESCRIPTION OF THE EMBODIMENTS

An example of an embodiment of an image forming apparatus and a method for controlling the image forming apparatus is described in detail below with reference to the attached drawings. The following embodiment does not limit the present disclosure, and not all combinations of features explained in the present embodiment are essential for a solution disclosed in the present disclosure. Further, the positions and the shapes of constituent elements described in the embodiment are just examples, and the embodiment does not purport to limit the scope of the present disclosure to these. (Schematic configuration of image forming apparatus)

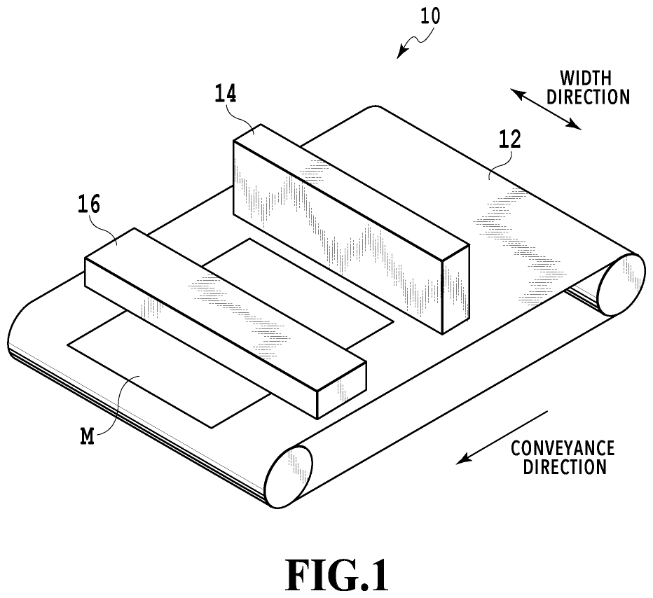

FIG. 1 is a schematic configuration diagram of an image forming apparatus. An image forming apparatus 10 according to the present embodiment includes a conveying part 12 conveying a print medium M in sheet form and a print head 14 performing printing by ejecting a printing agent on the print medium M conveyed by the conveying part 12. In the present embodiment, the printing agent is not limited to an ink containing a color material but includes a treatment liquid to apply a predetermined treatment to an ink ejected on the print medium M.

In the print head 14, a plurality of nozzles which eject an ink as droplets are arranged along a direction crossing (in the present embodiment, orthogonal to) a conveyance direction in which the print medium M is conveyed by the conveying part 12 in the range corresponding to the width of the print medium M on which printing can be performed. In a case where the print medium M passes a portion below the print head 14, an ejection energy generation element provided in such a way that the ejection energy generation element corresponds to each nozzle of the print head 14 is driven by control performed by a head control part 524 (described later), and printing is performed by ejecting the ink from the nozzles to the print medium M. In this way, in the present embodiment, the image forming apparatus 10 is a full-line type print apparatus which performs printing by ejecting the ink from each nozzle arranged along the width direction of the print medium M while continuously conveying the print medium M.

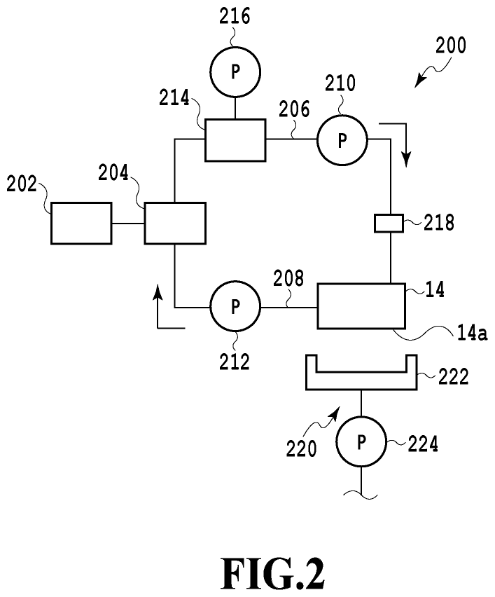

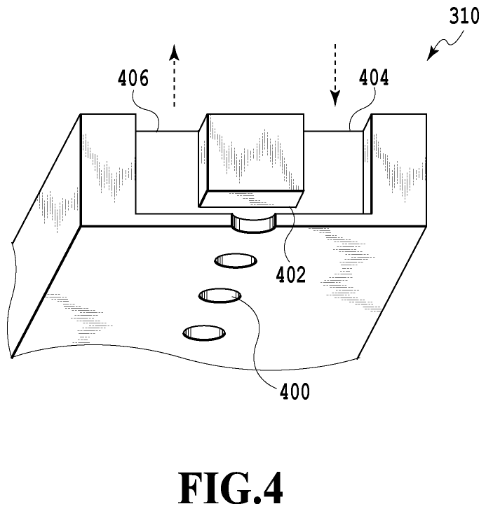

In the print head 14, a plurality of ink ejection parts 310 (see FIG. 4) in which a plurality of nozzles 400 (see FIG. 4) are open are arranged in a width direction in a plane (hereinafter, referred to as “nozzle plane”) 14a (see FIG. 2) opposite to the print medium M conveyed by the conveying part 12. In the present embodiment, in the ink ejection parts 310, a publically known ejection energy generation element such as a heating element, a piezo element, and an electrostatic element is provided in such a way that the publically known ejection energy generation element corresponds to each nozzle 400. Further, each nozzle ejects the ink by using energy generated by the ejection energy generation element provided in such a way that the ejection energy generation element corresponds to each nozzle.

The image forming apparatus 10 includes a main tank 202 (see FIG. 2) storing an ink to be supplied to the ink head 14. In the image forming apparatus 10, the ink stored in the main tank 202 is supplied to the print head 14 through a circulation path 200 (see FIG. 2) described later. Further, the image forming apparatus 10 includes a drying part 16 drying the ink ejected to the print medium M on a downstream side of the print head 14 in the conveyance direction and promoting the fixation of the ink to the print medium M.

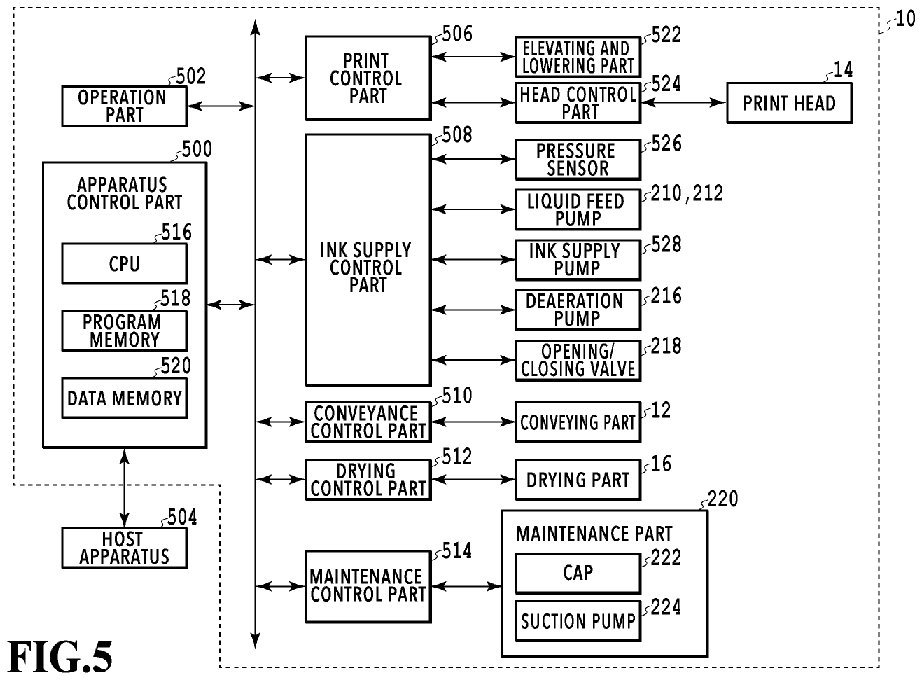

The image forming apparatus 10 includes a maintenance part 220 (see FIG. 2) to maintain and recover ink ejection performance in the print head 14. In the present embodiment, the maintenance part 220 is provided in such a way that the maintenance part 220 can reciprocally move from an upstream side to a downstream side in the conveyance direction and from the downstream side to the upstream side in the conveyance direction. In a case where a maintenance process for the print head 14 is performed by the maintenance part 220, first, the print head 14 is elevated by an elevating and lowering part 522 (see FIG. 5). Next, the maintenance part 220 is moved from a stand-by position to a maintenance position in which the maintenance process for the print head 14 can be performed. Subsequently, the maintenance process is performed by lowering the print head 14 and bringing the maintenance part 220 into contact with the print head 14.

The maintenance part 220 is configured so that the maintenance part 220 can perform various publically known maintenance processes. In the present embodiment, the maintenance part 220 includes a cap 222 (see FIG. 2) capping and protecting the nozzle plane 14a in which the nozzles are formed in the print head 14 and a suction pump 224 (see FIG. 2) causing a negative pressure inside the cap 222.

### (Circulation Path)

Next, an explanation about the circulation path 200 is made. FIG. 2 is a schematic configuration diagram of the circulation path 200. The circulation path 200 includes a buffer tank 204 storing the ink supplied from the main tank 202 and a supply flow path 206 supplying the ink stored in the buffer tank 204 to the print head 14. Further, the circulation path 200 includes a print head 14 ejecting the ink supplied through the supply flow path 206 and causing the ink which is not ejected to flow into a collection flow path 208 (described later). Furthermore, the circulation path 200 includes the collection flow path 208 collecting the ink flowing out from the print head 14 into the buffer tank 204.

Thus, the circulation path 200 is configured so that the ink circulates in such a way as to be collected into the buffer tank 204 after the ink is transferred to the buffer tank 204, the supply flow path 206, the print head 14, and the collection flow path 208 in this order. In this way, the circulation path 200 is configured to be capable of circulating the ink between the print head 14 and the buffer tank 204.

A liquid feed pump 210 to transfer the ink stored in the buffer tank 204 to the print head 14 is provided in the supply flow path 206. A liquid feed pump 212 to transfer the ink flowing out of the print head 14 to the buffer tank 204 is provided in the collection flow path 208.

A deaeration part (also referred to as “removal part”) 214 to remove dissolved gas in the ink is provided between the buffer tank 204 and the liquid feed pump 210 in the supply flow path 206. The deaeration part 214 is configured to perform decompression deaeration by using a hollow fiber membrane having a gas transmission property, and a deaeration pump 216 is connected to the deaeration part 214. Incidentally, a deaeration method performed by the deaeration part 214 is not limited to the above method, but it is possible to use various publically known methods by which the dissolved gas in the ink in the flow path can be reduced.

The supply flow path 206 includes an opening/closing valve 218 to be used in a case where a print head 14 after the replacement is filled with the ink, or the like between the liquid feed pump 210 and the print head 14. The opening/closing valve 218 is in an open state and allows the transfer of the ink in the circulation path 200 in a case where the ink circulates through the circulation path 200. Further, the opening/closing valve 218 is in a closed state and regulates the transfer of the ink to the print head 14 from the supply flow path 206 in a case where the inside of the print head 14 is decompressed or the like.

Incidentally, illustration is omitted, but filters to remove unnecessary solid bodies, dampers to suppress the pulsation of the ink flow rate in a case of the operation of the liquid feed pumps 210 and 212, and check valves to prevent backflow of the ink or the like are provided in the supply flow path 206 and the collection flow path 208. Further, various sensors to measure the circulation flow velocity of the ink, the ink flow rate, pressure or the like such as a pressure sensor 526 (see FIG. 5) detecting the pressure in a flow path (head internal flow path described below) inside the print head 14 are arranged in the circulation path 200. Various publically known techniques can be used for the above filters, dampers, check valves, and pressure sensor 526, and thus details on these are omitted.

### (Flow Path Configuration Inside Print Head)

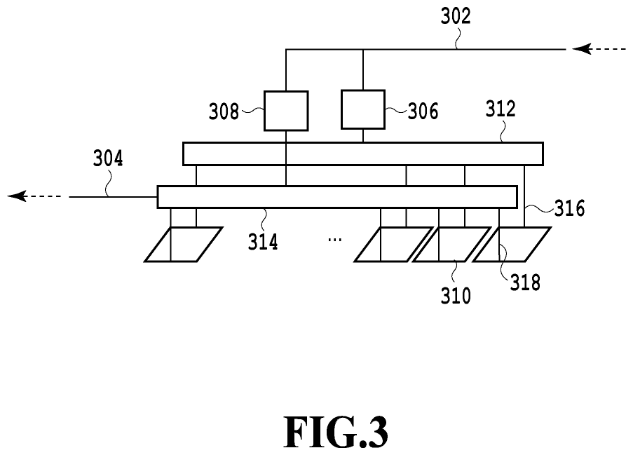

Next, a flow path configuration in the print head 14 is explained. FIG. 3 is a diagram illustrating the flow path configuration in the print head 14. FIG. 4 is a diagram illustrating a flow path in an ink ejection part.

The print head 14 includes an inlet path 302 to which the ink is supplied from the supply flow path 206 and an outlet path 304 causing the ink to flow into the collection flow path 208 (see FIG. 3). The ink flowing into the inlet path 302 is supplied to a first negative pressure control unit 306 and a second negative pressure control unit 308. In the first negative pressure control unit 306, a control pressure is set at a relatively low negative pressure, and in the second negative pressure control unit 308, a control pressure is set at a relatively high negative pressure. The first negative pressure control unit 306 and the second negative pressure control unit 308 are connected to the ink ejection parts 310 in which the nozzles 400 are provided and are configured to be capable of supplying the ink to the nozzles 400.

The first negative pressure control unit 306 and the second negative pressure control unit 308 operate on the principle of operation similar to what is generally called a decompression valve in order to control a negative pressure within a predetermined range, and at least part of an outer wall is formed of soft material such as a flexible film. Further, the first negative pressure control unit 306 and the second negative pressure control unit 308 are configured to press the outer wall with a press member such as a spring in a direction in which the volume of the flow path is enlarged. The first negative pressure control unit 306 and the second negative pressure control unit 308 adjust the negative pressure as a result of an outer wall portion such as the flexible film deforming and changing the volume of the flow path.

The plurality of ink ejection parts 310 are connected to the first negative pressure control unit 306 and the second negative pressure control unit 308. Specifically, the first negative pressure control unit 306 is connected to the plurality of ink ejection parts 310 via an ink branch path 312. The second negative pressure control unit 308 is connected to the plurality of ink ejection parts 310 via an ink meeting path 314.

The pressure difference between the first negative pressure control unit 306 and the second negative pressure control unit 308 causes the flow of an ink from the first negative pressure control unit 306 to the second negative pressure control unit 308 via the ink ejection parts 310. Thus, the ink supplied into the first negative pressure control unit 306 is fed to the ink branch path 312 and is then fed to the ink ejection parts 310 in the ink branch path 312 via a plurality of individual supply flow paths 316 connected to respective ink ejection parts 310. Further, the ink which is not ejected from the ink ejection parts 310 is fed to the ink meeting path 314 via individual collection flow paths 318 connected to the respective ejection parts 310 and is then fed to the outlet path 304 connected to the ink meeting path 314.

Incidentally, in the present embodiment, the print head 14 has an embodiment in which a plurality of ink ejection parts are connected to two negative pressure control units, but the present disclosure is not limited to this. For example, an embodiment in which one ink ejection part is connected to two negative pressure control units may be used.

A plurality of nozzles 400 are provided in an ink ejection part 310 (see FIG. 4). Each nozzle 400 is provided in a position corresponding to a pressure chamber 402 accommodating a supplied ink, and an ejection energy generation element (not illustrated) is arranged in each pressure chamber 402. An inlet port 404 into which an ink supplied from the individual supply flow path 316 flows and an outlet port 406 through which the ink from the pressure chamber 402 flows into the individual collection flow path 318 are connected to each pressure chamber 402.

Accordingly, the print head 14 includes the inlet path 302, the first negative pressure control unit 306, the second negative pressure control unit 308, the ink branch path 312, the ink meeting path 314, and the outlet path 304 therein. Further, the print head 14 includes the individual supply flow path 316, the inlet port 404, the pressure chamber 402, the outlet port 406, and the individual collection flow path 318 therein. In the following descriptions, these flow paths are collectively referred to as “head internal flow paths” as appropriate.

In the present embodiment, for the sake of easy understanding, a configuration in which the image forming apparatus 10 includes one print head 14 ejecting one type of ink is explained as an example. Incidentally, the image forming apparatus 10 is not limited to an embodiment which includes one print head 14, but may be an embodiment which includes a plurality of print heads 14. In this case, the number of the circulation paths 200 provided in the image forming apparatus 10 corresponds to the number of the print heads 14. Furthermore, the image forming apparatus 10 is not limited to an embodiment which ejects one type of ink from the print head 14 and may be an embodiment which ejects a plurality of types of inks from the print head 14. In this case, the circulation paths 200 corresponding to the respective inks are formed, and head internal flow paths corresponding to the respective inks are formed inside the print head 14.

### (Configuration of Control System of Image Forming Apparatus)

Next, the configuration of a control system of the image forming apparatus 10 is explained. FIG. 5 is a block diagram illustrating the configuration of the control system of the image forming apparatus 10.

The image forming apparatus 10 includes an apparatus control part 500 controlling the operations of the whole of the image forming apparatus 10 and an operation part 502 showing information to a user and receiving input of an instruction from the user. Incidentally, the apparatus control part 500 is connected to a host apparatus 504 provided separately from the image forming apparatus 10 and can receive input of various types of information such as a job from the host apparatus 504.

The image forming apparatus 10 includes a print control part 506 performing control of the print head 14 and an ink supply control part 508 controlling the supply of the ink to the print head 14 via the circulation path 200. Further, the image forming apparatus 10 includes a conveyance control part 510 controlling the conveying part 12, a drying control part 512 controlling the drying part 16, and a maintenance control part 514 controlling the maintenance part 220.

The apparatus control part 500 includes a CPU 516 which is in the form of a microprocessor, a program memory 518 which is in the form of a ROM, and a data memory 520 which is in the form of a RAM. The apparatus control part 500 receives an instruction from the host apparatus 504 or the operation part 502 and controls components of the image forming apparatus 10. A control program and a control parameter for each component are stored in the program memory 518 or the data memory 520, and the CPU 516 reads out these and controls each component.

The print control part 506 elevates and lowers the print head 14 by controlling the elevating and lowering part 522. Further, the print control part 506 controls the ejection of the ink from the print head 14 via the head control part 524. The conveyance control part 510 controls the conveyance of the print medium M by controlling the conveying part 12. The drying control part 512 promotes the fixation of the ink applied to the print medium M by controlling the drying part 16. The maintenance control part 514 performs various maintenance processes for the print head 14 by controlling the maintenance part 220.

The ink supply control part 508 detects based on detection results of the pressure sensor 526 detecting the pressure in the head internal flow path that the head internal flow path is filled with the ink. Further, the ink supply control part 508 controls the circulation of the ink in the circulation path 200 by controlling the liquid feed pumps 210 and 212. Further, the ink supply control part 508 controls the supply of the ink stored in the main tank 202 to the buffer tank 204 by controlling an ink supply pump 528. Furthermore, the ink supply control part 508 controls the removal of dissolved gas in the ink circulating through the circulation path 200 performed by the deaeration part 214 by controlling the deaeration pump 216. In addition, the ink supply control part 508 controls the supply of the ink to the head internal flow path of the print head 14 by controlling an opening/closing valve.

### (Print Process)

In the above configuration, in the image forming apparatus 10, the apparatus control part 500 receives a job including a print instruction and performs preparation processes to perform a print process and then performs the print process based on the job.

As the preparation processes, the apparatus control part 500 performs control via the conveyance control part 510 so that the print medium M is conveyed at a designated conveyance speed. Further, the apparatus control part 500 releases the capping of the print head 14 performed by the cap 222, that is, separates the cap 222 from the print head 14 via the maintenance control part 514. Furthermore, the apparatus control part 500 performs control via the drying control part 512 so that the print medium M can be dried on a condition set in the drying part 16. In addition, the apparatus control part 500 starts the circulation of the ink in the circulation path 200 performed by the liquid feed pumps 210 and 212 via the ink supply control part 508 and causes the deaeration part 214 to function by driving the deaeration pump 216.

On the completion of these preparation processes, the print process starts, and the apparatus control part 500 converts print data generated in the apparatus control part 500 into a drive signal in the head control part 524 via the print control part 506 and makes the ejection energy generation element of the print head 14 driven. In this case, the apparatus control part 500 controls the conveyance of the print medium M via the conveyance control part 510 and performs control so that the ink is ejected from the print head 14 to a predetermined position in the print medium and printing is performed.

(Filling of Head Internal Flow Path with Ink)

Incidentally, in a case where the print head 14 performs the print process, the head internal flow path is required to be filled with the ink. In the image forming apparatus 10, for example, the head internal flow path is filled with the ink at a predetermined timing such as the timing of the replacement of the print head 14. In a job of filling the head internal flow path with the ink, the ink is made to flow into the head internal flow path from the supply flow path 206 and the collection flow path 208 connected to the print head 14.

As a method for causing an ink to flow into the head internal flow path, a method for decompressing the head internal flow path or a method for applying a pressure from the supply flow path 206 and the collection flow path 208 or the like is used. In the method for decompressing the head internal flow path, the opening/closing valve 218 in the supply flow path 206 is closed, and air in the head internal flow path is sucked from the nozzles 400 to cause the head internal flow path to be in a decompression state. Then, the opening/closing valve 218 is opened to cause the ink to flow into the head internal flow path from the supply flow path 206 and the collection flow path 208. The method for decompressing the head internal flow path enables the head internal flow path to be filled with the ink uniformly as a result of the contraction of air swollen by the decompression of the head internal flow path. As a method for sucking air in the head internal flow path from the nozzles 400, for example, in a state where the nozzle plane 14a of the print head 14 is capped with the cap 222, the suction pump 224 is driven, a negative pressure is caused inside the cap 222, and air is sucked.

In the image forming apparatus 10, for example, the ink is made to flow into the head internal flow path by decompressing or pressurizing the head internal flow path to fill the head internal flow path with the ink, and at a timing at which the pressure in the head internal flow path returns to atmospheric pressure, the filling of the head internal flow path with the ink is completed. The pressure in the head internal flow path is detected by the pressure sensor 526, and the apparatus control part 500 determines based on detection results of the pressure sensor 526 whether the pressure in the head internal flow path reaches atmospheric pressure.

### (Concerns Arising in a Case of Ink Filling)

In the print head 14, in the head internal flow path, a portion in which a flow path cross-section area is relatively large and a portion in which a flow path bends in a substantially vertical direction exist. Thus, in a case where the head internal flow path is decompressed and is filled with the ink, air after the contraction is likely to remain in these portions, and it is less likely that the head internal flow path is filled with the ink. Further, residual bubbles are likely to accumulate in a portion positioned relatively above. For example, the negative pressure control units 306 and 308, the ink branch path 312, and the ink meeting path 314 have complex shapes, and there is a case where contracted air is trapped and stagnates near the top planes of respective portions as air bubbles.

Air bubbles which arise prevent the flow of the ink in the flow path and cause the sticking and the thickening of the ink in an interface with air. Further, sticking matter and thickening matter of the ink prevent the circulation flow of the ink and may cause the disruption of a state in which the ink is ejected from the nozzles 400 and ink non-ejection from the nozzles 400.

In particular, in a case where the air bubbles remain in portions whose flow path volume changes such as the negative pressure control units 306 and 308, the liquid surface of the ink fluctuates along with the change in the flow path volume. Further, in a case where the liquid surface lowers, part of the ink may be separated as a small droplet and be adhered to a wall. Such a small droplet which is isolated in the air bubbles has a large surface area as compared with the volume of the small droplet and a liquid component evaporates quickly and thus the ink is likely to be in a sticking state.

Further, in a case where the temperature around the air bubbles rises in a state where the air bubbles remain, the temperature in the residual bubbles also rises, and consequently, relative humidity decreases. Thus, the evaporation of the liquid component from the ink in the interface is promoted. Incidentally, in general, in a case where the print head 14 performs an ejection operation from the nozzles 400, the temperature in the surroundings of the print head 14 tends to rise because of heat dissipation from an electric substrate and heat transfer from the drying part 16.

### (Circulation Control)

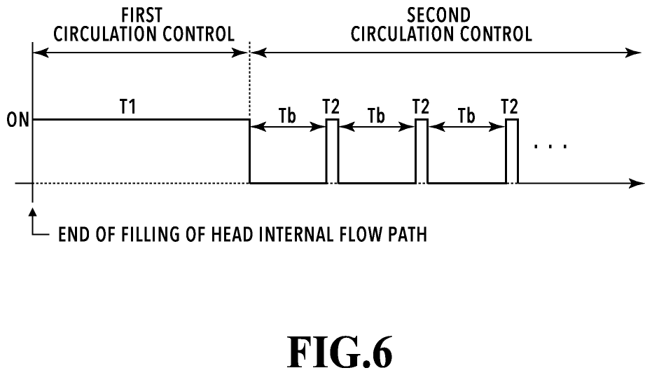

Then, in the present embodiment, after the print head 14 which has not been filled with the ink yet is filled with the ink, the circulation of the ink in the circulation path 200 starts before other processes and operations are performed. Incidentally, in a case of this circulation, the deaeration part 214 is made to function by driving the deaeration pump 216. Further, the circulation in the circulation path 200 is performed for a predetermined time in which the residual bubbles in the head internal flow path decrease to the extent that an ejection characteristic of the ink from each nozzle 400 is not reduced. Further, after a lapse of the predetermined time, the ink is made to intermittently circulate through the circulation path 200. In other words, in the present embodiment, after the head internal flow path is filled with the ink, in the circulation path 200, first circulation control which causes the ink to continuously circulate for the predetermined time is performed, and following the first circulation control, second circulation control which causes the ink to intermittently circulate is performed (see FIG. 6). FIG. 6 is a diagram illustrating the timing of the circulation of the ink in the circulation path 200 performed after the head internal flow path is filled with the ink.

The timing of the start of the circulation of the ink performed by the first circulation control is a timing immediately after the head internal flow path is filled with the ink or a timing at least before other processes and operations are performed. The other processes and operations are, for example, ejection operations performed by the print head 14. Incidentally, the ejection operations in the print head 14 include a print operation (that is, print process) of printing the print medium M, an ejection operation for the cap 222 to confirm an ejection state, and an ejection operation to age the ejection energy generation element.

In the first circulation control, by performing the circulation of the ink while the deaeration part 214 is made to function, the amount of dissolved gas in the circulating ink is reduced, and the air bubbles remaining in the head internal flow path are made to be dissolved in the ink whose amount of dissolved gas is reduced by continuing the circulation for the predetermined time. The air bubbles remaining in the head internal flow path can be thereby reduced. Further, following the first circulation control, in the second circulation control, the circulation of the ink is intermittently performed by making the deaeration part 214 function, and the thickening of the ink in the nozzle and the precipitation of content components in the ink can be suppressed thereby.

Specifically, in the image forming apparatus 10, in a case where the apparatus control part 500 detects based on detection results of the pressure sensor 526 via the ink supply control part 508 that the pressure in the head internal flow path reaches atmospheric pressure, the apparatus control part 500 drives the liquid feed pumps 210 and 212, and performs the first circulation control. In order to suppress the sticking of the ink caused by the residual bubbles, it is desirable that the first circulation control be performed soon after ink filling. In this way, in the present embodiment, the apparatus control part 500 and the ink supply control part 508 function as control parts which control the circulation of the ink in the circulation path 200 while removing the residual bubbles in the ink by using the deaeration part 214.

In the first circulation control, the circulation of the ink is continuously performed for a predetermined time T1 while the deaeration part 214 is made to function in the circulation path 200. The predetermined time T1 is, for example, a time in which the volume of the residual bubbles arising in the head internal flow path decreases to the extent that the ejection characteristic of the ink from each nozzle 400 is not reduced. A lower limit value of the predetermined time T1 is, for example, preferably 100 hours or more, and more preferably, 200 hours or more. Incidentally, an upper limit value of the predetermined time T1 is, for example, a time in which the residual bubbles in the head internal flow path cannot be decreased even in a case where an ink whose amount of dissolved gas is reduced is circulated. Specifically, the predetermined time T1 is, for example, 1000 hours or less. Incidentally, the predetermined time T1 is experimentally determined according to, for example, the type of ink to be used, the shapes of the circulation path 200 and members which constitute the circulation path 200, and an environment in which the image forming apparatus 10 is used.

Upon the completion of the first circulation control, that is, the completion of the circulation of the ink in the circulation path 200 which continues for the predetermined time T1 (or a time corresponding to the predetermined time T1), the second circulation control is performed. In the second circulation control, the circulation of the ink is performed intermittently. In other words, in the second circulation control, the performance and the stop of the circulation of the ink in the circulation path 200 are alternately and repeatedly performed. Incidentally, a case where the circulation is performed only once after the stop of circulation is included in the second circulation control. In the second circulation control, the circulation of the ink in the circulation path 200 stops for a first time Tb, the circulation of the ink in the circulation path 200 is performed for a second time T2, and the stop of the circulation for the first time Tb and the performance of the circulation for the second time T2 are repeatedly performed. In other words, in the second circulation control, a pattern where the circulation of the ink stops for the first time Tb and then the circulation of the ink is performed for the second time T2 is performed continuously.

The first time Tb is, for example, a lower limit value of a stop time in which the thickening of the ink in the nozzle caused by the evaporation of a liquid component, the precipitation of the content components of the ink in the circulation path 200, and the deviation of an ink temperature in the circulation path 200 or the like arise because of the stop of the circulation and therefore the ejection characteristic of the ink can be reduced. The second time T2 is, for example, a lower value of a time in which the circulation can solve the thickening of the ink in the nozzle caused by the evaporation of the liquid component, the precipitation of the content components of the ink in the circulation path 200, and the deviation of the ink temperature in the circulation path 200 or the like.

In this way, while the first circulation control is performed with the purpose of reducing the residual bubbles in the head internal flow path, the second circulation control is performed with the purpose of suppressing the thickening of the ink from the nozzles, preventing the precipitation of the content components of the ink, and leveling the ink temperature or the like. Incidentally, the second circulation control is performed until, for example, a timing at which the print head 14 is replaced next.

In the first circulation control and the second circulation control, the ink is circulated in the circulation path 200 by driving the liquid feed pumps 210 and 212. Thus, from the perspective of the durability of the liquid feed pumps 210 and 212, it is preferable that the second time T2 be a short time. In the present embodiment, the relation between the predetermined time T1 and the second time T2 in which the liquid feed pumps 210 and 212 are driven is T1>T2. Thus, in the image forming apparatus 10 according to the present embodiment, as compared with a publically known technique in which an ink is always circulated in a circulation path, lifetimes of the liquid feed pumps 210 and 212 can be extended while residual bubble removal performance is maintained.

Further, from the perspective of the durability of the liquid feed pumps 210 and 212, it is preferable that the first time Tb be as long as possible without departing from the purpose of the second circulation control. Specifically, the sum of the first time Tb and the second time T2 is, for example, from 11 minutes to 28 hours, and the second time T2 is, for example, five minutes. In other words, in a case where the second time T2 is on the order of five minutes and the sum of the first time Tb and the second time T2 is from 11 minutes to 28 hours, the purpose to be achieved by the second circulation control is feasible, and the lifetimes of the liquid feed pumps 210 and 212 can be extended. In particular, by determining that the relation between the predetermined time T1, the first time Tb, and the second time T2 is T1>Tb>T2, the lifetimes of the liquid feed pumps 210 and 212 can be extended more reliably while the residual bubble removal performance is maintained.

### (Specific Circulation Control)

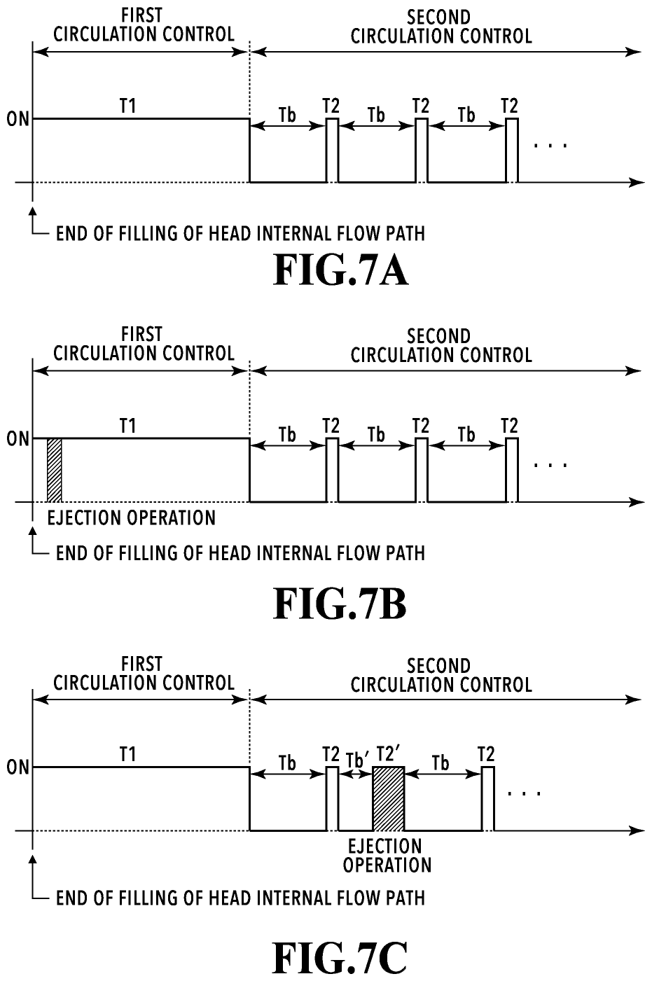

Next, an execution example of specific circulation control is described. FIGS. 7A to 7C are diagrams illustrating the execution example of specific circulation control. FIG. 7A is an execution example of circulation control which is a reference. FIG. 7B is an execution example of the circulation control in a case where an ejection operation is performed during the first circulation control. FIG. 7C is an execution example of the circulation control in a case where an ejection operation is performed during the second circulation control.

In the image forming apparatus 10, even in the circulation control, an ejection operation accompanied by the circulation of the ink in the circulation path 200 can be performed for the sake of printing and other purposes. Specifically, the ejection operation can be performed during the first circulation control, and the ejection operation can be performed during the second circulation control.

First, a case where the ejection operation is performed during the first circulation control is explained. In the first circulation control, after the start of the circulation of the ink in the circulation path 200, the circulation continues until the predetermined time T1 passes. In the present embodiment, for example, at a predetermined timing after the start of the circulation, even in a case where the ejection operation accompanied by the circulation of the ink in the circulation path 200 is performed, the first circulation control ends at a point in time at which the predetermined time T1 is reached regardless of time necessary for the ejection operation (see FIG. 7B).

In other words, even though the ejection operation is performed during the first circulation control, the first circulation control ends at the same timing as in a case (see FIG. 7A) where the ejection operation is not performed during the first circulation control. Incidentally, in a case where the ejection operation is performed for over the predetermined time T1, the first circulation control ends at a timing at which the ejection operation ends.

Next, a case where the ejection operation is performed during the second circulation control is explained. In the second circulation control, after the end of the first circulation control, the circulation of the ink is intermittently performed in such a way that the circulation of the ink in the circulation path 200 is stopped for the first time Tb and then the circulation of the ink in the circulation path 200 is performed for the second time T2.

In the present embodiment, in a case where the ejection operation is performed during the second circulation control, the circulation of the ink in the circulation path 200 accompanied by the ejection operation is regarded as circulation performed during the second circulation control regardless of a timing at which the ejection operation is performed. Specifically, in a case where the ejection operation is performed for the first time Tb, the circulation of the ink in the circulation path 200 accompanied by the ejection operation is regarded as circulation of the ink performed for the second time T2 regardless of whether a time of the circulation of the ink in the circulation path 200 accompanied by the ejection operation is long or short (see FIG. 7C). In this case, a time for which the circulation of the ink stops is a time Tb′ which is shorter than the first time Tb, and time for which the circulation of the ink is performed is a time T2′ which is different from the second time T2 and is necessary for the ejection operation. Further, the circulation of the ink is stopped for the first time Tb from a point in time in which the ejection operation ends, and then the circulation of the ink is performed for the second time T2. In other words, in a case where the ejection operation is performed during the second circulation control, regardless of whether a time necessary for the ejection operation is long or short, after the ejection operation ends, the circulation of the ink is intermittently performed in a predetermined pattern where the stop of the circulation for the first time Tb and the performance of the circulation for the second time T2 are repeated.

### (Circulation Time in First Circulation Control)

Next, the predetermined time T1 which is a circulation time in which the ink is circulated in the circulation path 200 in the first circulation control is explained.

In a case where the circulation path 200 is filled with the ink by decompressing the head internal flow path, the predetermined time T1 which is a circulation time of the ink in the first circulation control can be determined based on a negative pressure value reached in a case where the head internal flow path is decompressed. Hereinafter, a method for determining the predetermined time T1 is explained, but for example, the predetermined time T1 may be determined based on a negative pressure value by obtaining the negative pressure value of the head internal flow path reached in a case of decompression every time the head internal flow path is filled with the ink. Alternatively, a negative pressure value of the head internal flow path in a case where the head internal flow path is decompressed in a case of factory shipment or the like is obtained, the predetermined time T1 is determined based on the negative pressure value, and the determined predetermined time T1 may be set as a circulation time of the ink in the first circulation control.

The higher the negative pressure value reached in the head internal flow path in a case where decompression is performed becomes, the greater the contraction rate of gas in the head internal flow path in a case where the ink subsequently flows into the head internal flow path and the head internal flow path returns to a normal pressure becomes, and thus the amount of residual bubbles in the head internal flow path after the head internal flow path is filled with the ink is small.

Given that the volume of the head internal flow path is D1, atmospheric pressure is P1, and a reached negative pressure is P2, the volume D2 of the residual bubbles after ink filling is represented by the following formula (1):

D2=(P1+P2)×D1/P1 (1)

For example, given that D1 is 200 ml, P1 is 100 kPa, and P2 is −80 kPa, D2 is calculated at 40 ml by the above formula (1).

The predetermined time T1 which is a circulation time of the ink necessary for the removal of the residual bubbles after the ink filling mainly changes according to the ink flow rate and the degree of the deaeration of the ink in a case of ink circulation. The ink flow rate is controlled by the amount of liquid feed of the liquid feed pumps 210 and 212, and the degree of the deaeration of the ink is controlled by the performance of the deaeration part 214, and the ink flow rate and the degree of the deaeration of the ink are unique values for each body of the image forming apparatus 10.

Given that a constant unique to a body determined by the ink flow rate and the degree of the deaeration of the ink is k, the predetermined time T1 is represented by the following formula (2):

T1=k×D2 (2)

The pressure sensor 526 to measure P2, for example, may be arranged in any position in the head internal flow path or may be arranged in the cap 222. Alternatively, the pressure sensor 526 to measure P2 may be arranged in a flow path from the opening/closing valve 218 to the inlet path 302.

### (Preferable Ink Used for the Circulation Control According to the Present Disclosure)

Next, a preferable ink used for the image forming apparatus 10 performing the circulation control according to the present embodiment is explained. Incidentally, an ink used for the image forming apparatus 10 performing the circulation control according to the present embodiment is not particularly limited.

### <Thermoplastic Resin Fine Particles-Containing Ink>

As a preferable ink used for the image forming apparatus 10 performing the circulation control according to the present embodiment, for example, there is an ink which can have qualities such as the fastness of an image of a printed subject and contains thermoplastic resin fine particles.

The thermoplastic resin fine particles include an effect of imparting scratch resistance and water fastness to an image as a result of at least part of the thermoplastic resin fine particles softening or melting in a case where the image formed by ejecting the ink is heated at a glass transition temperature or more. As specific materials for the thermoplastic resin fine particles, there are polystyrene, polyvinyl chloride, polyethylene, polypropylene, and polymethacrylic acid ester. The thermoplastic resin fine particles can be dispersed in the ink by a method for dispersion by using a resin dispersant and a method for bonding a hydrophilic group such as an anionic group and a fine particle surface together in a direct way or via another atomic group.

It is preferable that the weight-average molecular weight (Mw) of the thermoplastic resin fine particles be from 1,000 to 2,000,000. It is preferable that the volume-average particle diameter of thermoplastic resin fine particles measured by dynamic light scattering be from 10 nm to 1,000 nm, more preferably, from 100 nm to 500 nm. It is preferable that the content (% by mass) of the thermoplastic resin fine particles in the ink be from 1.0% to 50.0% by mass with respect to the total mass of the ink, more preferably, from 2.0% to 40.0% by mass.

The ink containing the thermoplastic resin fine particles is likely to generate sticking matter because in an interface of air bubbles remaining in the head internal flow path or the like, a dispersion state is broken by the evaporation of the liquid component and the thermoplastic resin fine particles agglomerate or perform melt-adhesion together. Accordingly, in the image forming apparatus 10 which uses the ink containing such thermoplastic resin fine particles, the generation of sticking matter can be suppressed by performing the above circulation control of the ink, and both the stability of the ejection characteristic and the fastness of an image can be achieved.

### <Non-Volatile Solvent-Containing Ink>

Further, as a preferable ink used for the image forming apparatus 10 performing the circulation control according to the present embodiment, for example, there is an ink in which the content of a non-volatile solvent is 1% by weight or less. Incidentally, as the ink in which the content of the non-volatile solvent is 1% by weight or less includes an ink in which the content of the non-volatile solvent is 0% by weight, that is, an ink which does not contain the non-volatile solvent.

The non-volatile solvent is used for the purpose of the prevention of the drying of the ink and suppresses the occurrence of the sticking of the ink near an interface of air bubbles even in a case where the air bubbles remain in the head internal flow path. In the present embodiment, the non-volatile solvent refers to a solvent whose boiling point is 250° C. or more and includes, for example, polyhydric alcohol, polyhydric alcohol ether, acetate, amines or the like. On the other hand, the non-volatile solvent may reduce scratch resistance and water fastness as a result of the non-volatile solvent remaining in an image formed by ejecting an ink containing the non-volatile solvent.

Even such an ink in which the content of the non-volatile solvent is low or an ink which is substantially free of the non-volatile solvent, that is, an ink in which the content of the non-volatile solvent is 1% by weight or less can suppress the generation of sticking matter in the interface of the air bubbles remaining in the head internal flow path by performing the circulation control of the ink mentioned above. The content of a non-volatile solvent in the ink is preferably 1% by weight or less, more preferably, 0.1% by weight or less.

In a case where the ink contains a high content of the non-volatile solvent, it takes time to dry the ink, and thus, for example, the conveyance distance in the drying part becomes longer and an apparatus is upsized, and the drying time in the drying part becomes longer and a time necessary for printing becomes longer. However, by performing the circulation control mentioned above and using the ink in which the content of the non-volatile solvent is 1% by weight or less, the occurrence of the sticking of the ink caused by the air bubbles can be suppressed while the upsizing of the apparatus and an increase in printing time are suppressed.

### (Operation and Effect)

As explained above, in the image forming apparatus according to the present embodiment, the first circulation control in which the ink is circulated continuously after the head internal flow path constituting the circulation path for the ink is filled with the ink is performed, and then the second circulation control in which the ink is intermittently circulated is performed. Therefore, in the image forming apparatus according to the present embodiment, high cost can be suppressed by reducing the residual bubbles generated in the head internal flow path and the frequency of the replacement of a pump in the circulation path.

Further, a time (second time T2) necessary for one circulation in the second circulation control is shorter than a time (first time Tb) for which the one circulation in the second circulation control is stopped, and the time for which the one circulation in the second circulation control is stopped is shorter than a time (predetermined time T1) necessary for the circulation in the first circulation control. The lifetime of the liquid feed pump can be extended thereby more reliably.

### OTHER EMBODIMENTS

Incidentally, the above-mentioned embodiment may be modified as shown in the following (1) to (6).
(1) Although not particularly described in the above embodiment, in a case where a plurality of print head 14 are included in the image forming apparatus 10, an ink containing thermoplastic resin fine particles and an ink not containing thermoplastic resin fine particles may be ejected from the different print heads 14, for example. Incidentally, the ink not containing thermoplastic resin fine particles includes, for example, a treatment liquid reducing the fluidity of the ink containing thermoplastic resin fine particles. Such a treatment liquid prevents the degradation of image quality as a result of adjacent ink dots drawing and mixing together on a print medium due to the ejection.

It is not likely that the ink not containing thermoplastic resin fine particles generates solid matter because of the drying also in the residual bubble in the head internal flow path. Thus, after the print head 14 is filled with the ink, there is no need to circulate the ink for the predetermined time T1. Accordingly, in the circulation path 200 including the print head 14 ejecting the ink not containing thermoplastic resin fine particles, the second circulation control, that is, intermittent circulation may be immediately performed by omitting the first circulation control. In this case, different circulation controls are performed for the circulation path 200 including the print head 14 which is filled with the ink containing thermoplastic resin fine particles and the circulation path 200 including the print head 14 which is filled with the ink not containing thermoplastic resin fine particles, respectively. Specifically, in the circulation path 200 including the print head 14 which is filled with the ink containing thermoplastic resin fine particles, the first circulation control and the second circulation control are performed. In contrast, in the circulation path 200 including the print head 14 which is filled with the ink not containing thermoplastic resin fine particles, only the second circulation control is performed.
(2) In the above embodiment, the predetermined time T1 which is a time of the circulation of the ink performed by the first circulation control is not changed regardless of the presence or absence of the performance of the ejection operation during the first circulation control, but the present disclosure is not limited to this. The predetermined time T1 may be changed according to the ejection operation performed during the first circulation control. Hereinafter, the change of the predetermined time T1 according to the ejection operation performed during the first circulation control is explained.

For example, in a case where a print operation is performed as an ejection operation during the first circulation control, the flow velocity of an ink to be circulated during the print operation is made different from that of an ink to be circulated in the first circulation control. In general, the flow velocity of an ink in a case of circulation has an effect on the ejection state of the ink from a nozzle and thus is required to fall within a predetermined range which does not influence the ejection state in a case of the print operation. In contrast, in a case of circulation control to reduce residual bubbles in the head internal flow path, it is desirable that the air bubbles contact deaerated ink more in order to remove the air bubble in the flow path, and it is preferable that the flow velocity be as high as possible. In the present embodiment, the flow velocity of the ink in a case of the print operation is, for example, 400 ml/min, and the flow velocity in a case of the first circulation control is, for example, 800 ml/min.

Therefore, in a case where the print operation is performed during the first circulation control, the residual bubbles in the head internal flow path can be reduced more reliably by changing the length of the predetermined time T1 according to the flow velocity of the ink in a case of the print operation. Here, in a case where the print operation is performed during the first circulation control, the flow velocity of the ink in a case of the print operation is lower than that of the ink during the first circulation control, and air bubble removal performance in the head internal flow path is reduced in a case of the print operation. Therefore, the residual bubbles in the head internal flow path are reduced more reliably by extending the predetermined time T1 which is a total circulation time for the ink in a case of the first circulation control according to a time required for the print operation and the flow velocity of the ink in a case of the print operation.

For example, the flow velocity of the ink in a case of the first circulation control is Va (ml/min), the predetermined time T1 is Ta (min), the flow velocity of the ink in the circulation in a case of the print operation is Vb (ml/min), a time in which the circulation of the ink is performed at the flow velocity Vb is Tb (min). In this case, a predetermined time T1′ after the change is determined by the following formula (3):

T1′={(Va×Ta)−(Vb×Tb)}/Va+Tb (3)

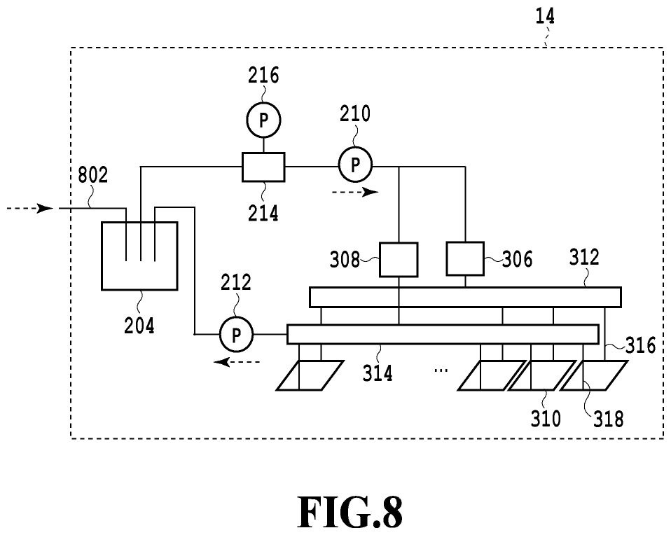

For example, assume that in a case where the flow velocity of the ink in a case of the first circulation control is 800 ml/min and the predetermined time T1 is 200 hours, a print operation in which the flow velocity of the ink is 400 ml/min is performed for 10 hours during the first circulation control. In this case, the predetermined time T′ after the change is 205 hours from the formula (3) mentioned above, and the predetermined time T1 is extended for five hours.
(3) In the above embodiment, the deaeration part 214, the deaeration pump 216, the liquid feed pumps 210 and 212, and the buffer tank 204 are provided outside the print head 14 in the circulation path 200, but the present disclosure is not limited to this. For example, as in FIG. 8, the deaeration part 214, the deaeration pump 216, the liquid feed pumps 210 and 212, and the buffer tank 204 may be provided inside the print head 14, and a circulation path may be provided inside the print head 14. In this case, an ink is supplied to the buffer tank 204 via a flow path 802 connected to the main tank 202. In this way, even in a case where the circulation path is formed in the print head 14, an operation and an effect similar to the above embodiment can be obtained by performing circulation control of the ink as in the above embodiment. Incidentally, in a case where the circulation path is formed inside the print head 14, the first circulation control starts immediately after a timing at which the inside of the circulation path is filled with the ink, that is, the filling.
(4) Although not particularly described in the above embodiment, a heater which can keep the print head 14 at a set temperature may be provided in the print head 14, and in a case of the circulation operation, the print head 14 may be kept by the heater at the set temperature. Further, in the above embodiment, the image forming apparatus 10 includes a so-called full-line type print head in which the nozzle array whose length corresponds to the length in the width direction of the print medium M in which printing can be performed is extended in the width direction of the print medium M, but the present disclosure is not limited to this. The image forming apparatus 10 may include a so-called serial scanning type print head which includes a nozzle array extending in a direction crossing the width direction of the print medium and which ejects an ink while moving in the width direction.
(5) Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.
(6) The above embodiment and the embodiments of various types indicated in
(1) to (5) mentioned above may be combined as appropriate.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

According to the present disclosure, high cost can be suppressed while the air bubbles are reduced.

This application claims the benefit of Japanese Patent Application No. 2024-145376, filed Aug. 27, 2024, which is hereby incorporated by reference herein in its entirety.

What is claimed is:

1. An image forming apparatus comprising:
a print head performing printing by ejecting a supplied printing agent from a nozzle;
a circulation path which includes an internal flow path communicating with the nozzle and formed inside the print head, supplies the printing agent to the print head, and collects the printing agent not ejected from the print head and through which the printing agent circulates;
a removal unit configured to remove dissolved gas in the printing agent circulating through the circulation path; and
a control unit configured to control the removal unit and circulation of the printing agent in the circulation path, wherein
in a case where the internal flow path of the print head is filled with the printing agent, in the circulation path, after first circulation control in which the printing agent is continuously circulated for a first time while the dissolved gas is removed by the removal unit is performed, the control unit performs second circulation control in which circulation of the printing agent which is performed for a second time shorter than the first time is intermittently performed.

2. An image forming apparatus comprising:
a print head including a circulation path which supplies a supplied printing agent to a nozzle and collects the printing agent not ejected from the nozzle and through which the printing agent circulates and performing printing by ejecting the printing agent from the nozzle;
a removal unit configured to remove dissolved gas in the printing agent which circulates through the circulation path; and
a control unit configured to control the removal unit and circulation of the printing agent in the circulation path; wherein
in a case where the circulation path of the print head is filled with the printing agent, in the circulation path, after first circulation control in which the printing agent is continuously circulated for a first time while the dissolved gas is removed by the removal unit is performed, the control unit performs second circulation control in which circulation of the printing agent which is performed for a second time shorter than the first time is intermittently performed.

3. The image forming apparatus according to claim 1, wherein
a timing of start of the first circulation control is a timing before start of an ejection operation of the printing agent from the print head.

4. The image forming apparatus according to claim 1, wherein
a timing of start of the first circulation control is a timing immediately after inside of the print head is filled with the printing agent.

5. The image forming apparatus according to claim 1, further comprising
a detection unit configured to detect that a pressure in a flow path through which the printing agent circulates reaches atmospheric pressure, wherein
the circulation unit starts the first circulation control based on a detection result obtained by the detection unit.

6. The image forming apparatus according to claim 1, wherein
in the second circulation control, a time for which circulation of the printing agent is stopped is a third time which is shorter than the first time and is longer than the second time.

7. The image forming apparatus according to claim 1, further comprising
a suction unit configured to cause a negative pressure in the internal flow path via a nozzle of the print head, and
a valve regulating and allowing supply of the printing agent to the internal flow path, wherein
in a state where the supply of the printing agent to the internal flow path is regulated by the valve, the control unit causes the internal flow path to be filled with the printing agent by allowing the supply of the printing agent to the internal flow path by using the valve after the negative pressure is caused in the internal flow path by the suction unit via the printing agent.

8. The image forming apparatus according to claim 1, wherein
the printing agent is an ink containing a thermoplastic resin fine particle.

9. The image forming apparatus according to claim 1, wherein
the printing agent is an ink containing 1% or less by weight of a non-volatile solvent whose boiling point is 250° C. or more.

10. The image forming apparatus according to claim 1, wherein
the print head includes a first print head ejecting an ink containing a thermoplastic resin fine particle as the printing agent and a second print head ejecting an ink not containing the thermoplastic resin fine particle as the printing agent;
in the circulation path including the first print head, the control unit performs the second circulation control after performing the first circulation control; and
in the circulation path including the second print head, the control unit performs the second circulation control.

11. The image forming apparatus according to claim 1, wherein
a flow path through which the printing agent circulates in the print head has a portion in which a flow path cross-section area is relatively large and a portion which bends in a substantially vertical direction.

12. The image forming apparatus according to claim 1, wherein
a flow path through which the printing agent circulates in the print head has a portion in which a flow path volume changes.

13. The image forming apparatus according to claim 1, wherein
the control unit circulates the printing agent in the circulation path while the dissolved gas is removed by the removal unit in response to an ejection operation in a case where the ejection operation is performed during the first circulation control.

14. The image forming apparatus according to claim 1, wherein
the control unit circulates the printing agent in the circulation path while the dissolved gas is removed by the removal unit in response to an ejection operation in a case where the ejection operation is performed during the second circulation control.

15. The image forming apparatus according to claim 1, wherein
the control unit circulates the printing agent in the circulation path while the dissolved gas is removed by the removal unit in response to an ejection operation in a case where the ejection operation is performed during the first circulation control, and changes the first time according to flow velocity of the printing agent in circulation accompanied by the ejection operation and a time for which the circulation is performed.

16. The image forming apparatus according to claim 1, wherein
the control unit is configured to:
in the second circulation control, stop circulation for a third time which is shorter than the first time and longer than the second time and then performs intermittent circulation of the printing agent in a predetermined pattern in which performance of circulation is repeated for the second time;
circulate the printing agent in the circulation path while the dissolved gas is removed by the removal unit in response to an ejection operation in a case where the ejection operation is performed during the second circulation control; and
perform the intermittent circulation of the ink in the predetermined pattern from a timing at which the ejection operation ends in a case where the ejection operation is performed during the second circulation control.

17. The image forming apparatus according to claim 1, wherein
the first time is 100 hours or more.

18. The image forming apparatus according to claim 1, wherein
the second circulation control stops circulating the printing agent for a third time which is shorter than the first time and longer than the second time and then continuously performs a pattern in which circulation of the printing agent is performed for the second time, and
sum of the second time and the third time is 28 hours or less.

19. A method for controlling an image forming apparatus having a print head performing printing by ejecting a supplied printing agent from a nozzle;
a circulation path which includes an internal flow path communicating with the nozzle and formed inside the print head, supplies the printing agent to the print head, and collects the printing agent not ejected from the print head and through which the printing agent circulates; and
a removal unit configured to remove dissolved gas in the printing agent circulating through the circulation path; wherein
in a case where the internal flow path of the print head is filled with the printing agent, in the circulation path, after a first circulation control in which the printing agent is continuously circulated for a first time while the dissolved gas is removed by the removal unit is performed, second circulation control in which circulation of the printing agent which is performed for a second time shorter than the first time is intermittently performed is performed.

20. A method for controlling an image forming apparatus having
a print head including a circulation path which supplies a supplied printing agent to a nozzle and collects the printing agent not ejected from the nozzle and through which the printing agent circulates and performing printing by ejecting the printing agent from the nozzle; and
a removal unit configured to remove dissolved gas in the printing agent which circulates through the circulation path; wherein
in a case where the circulation path of the print head is filled with the printing agent, in the circulation path, after a first circulation control in which the printing agent is continuously circulated for a first time while the dissolved gas is removed by the removal unit is performed, second circulation control in which circulation of the printing agent which is performed for a second time shorter than the first time is intermittently performed is performed.
